(19) United States
(12) Patent Application Publication
(10) Pub. No.: US 2009/0325847 A1
(43) Pub. Date: Dec. 31, 2009

(54) Process for Preparing a Powder

(76) Inventors: Hossam Hassan Tantawy, Northumberland (GB); Nigel Patrick Somerville Roberts, Newcastle upon Tyne (GB); Urwin Harrogate, Northumberland (GB); David William York, Newcastle (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/486,781

(22) Filed: Jun. 18, 2009

(30) Foreign Application Priority Data
Jun. 25, 2008 (EP) 08159022.6

(51) Int. Cl. C11D 3/06

(52) U.S. Cl. 510/276

(57) ABSTRACT

The present invention relates to a process for preparing a powder comprising:
(i) anionic detersive surfactant;
(ii) from 0 wt % to 10 wt % zeolite builder;
(iii) from 0 wt % to 10 wt % phosphate builder; and
(iv) from 0 wt % to 15 wt % silicate salt;
   wherein the process comprises the steps of:
(a) forming a slurry that comprises a volatile compound; and
(b) spraying the slurry through a nozzle into a drying apparatus; and
(c) drying the slurry to form a powder,
   wherein the slurry enters the nozzle at conditions such that either:
(I) at the temperature at which the slurry enters the nozzle, the slurry is at a pressure that is equal to or greater than the vapour pressure of the volatile component, and wherein, the slurry enters the nozzle at a temperature such that the vapour pressure of the volatile compound is above the pressure in the drying apparatus; or
(II) the volatile component is in supercritical form when the slurry enters the nozzle, and wherein, the conditions in the drying apparatus are such that when the volatile component enters the drying apparatus, at least a portion of the volatile component is in gaseous form.

### FIELD OF THE INVENTION

The present invention relates to a process for preparing a powder.

### BACKGROUND OF THE INVENTION

There is a recent trend in the laundry detergent industry to produce low-built laundry powders. These are typically produced by a process involving a drying step. However, during conventional drying steps, such as conventional spray-drying, the low-built powders produced by these processes have a poor stability profile. This is exacerbated when a significant amount of silicate salt is present in the spray-dried powder. The Inventors have overcome this problem by incorporating a volatile compound into the detergent slurry making process, and carefully controlling the pressure during the process such that low-built, anionic detersive surfactant-containing powders are produced that have good stability profiles.

### SUMMARY OF THE INVENTION

The present invention relates to a process as defined by claim 1.

### DETAILED DESCRIPTION OF THE INVENTION

### Spray-Drying Process

The process comprises the steps of: (a) forming a slurry that comprises a volatile compound; and (b) spraying the slurry through a nozzle into a drying apparatus; and (c) drying the slurry to form a powder. The slurry enters the nozzle at one of two of the below described conditions.
(I) At the temperature at which the slurry enters the nozzle, the slurry is at a pressure that is equal to or greater than the vapour pressure of the volatile component. In addition, the slurry enters the nozzle at a temperature such that the vapour pressure of the volatile compound is above the pressure in the drying apparatus.
(II) The volatile component is in supercritical form when the slurry enters the nozzle. In addition, when the volatile component is in supercritical form when the slurry enters the nozzle, the conditions in the drying apparatus are such that when the volatile component enters the drying apparatus, at least a portion, preferably essentially all of the volatile component is in gaseous form.

Preferably, in step (b) the slurry is sprayed at a temperature of below 150° C., or below 125° C., or below 100° C., or below 90° C., or below 80° C., or below 70° C., or even below 60° C. into the drying apparatus.

Preferably, the powder is in spray-dried form, and wherein the drying apparatus is a spray-drying tower. Alternatively, the drying apparatus is a powder mixing apparatus and/or a fluid bed dryer.

Preferably, the powder produced in step (c) is contacted with non-ionic detersive surfactant.

### Powder

The powder comprises (i) anionic detersive surfactant; (ii) from 0 wt % to 10 wt % zeolite builder; (iii) from 0 wt % to 10 wt % phosphate builder; and (iv) from 0 wt % to 15 wt % silicate salt. Preferably, the powder comprises from 3 wt % to 15 wt % silicate salt. The powder preferably comprises a carbonate salt. The powder may comprise detergent adjunct ingredients. The powder is preferably in spray-dried form.

### Slurry

Typically, the slurry comprises water; the slurry is typically an aqueous slurry. The slurry comprises a volatile component. This is preferably formed by injection of the volatile component into the slurry under pressure. Alternatively, it could be formed by the in-situ formation of the volatile component in the slurry, e.g. by the neutralization of an acid anionic surfactant precursor with a carbonate salt. The volatile component may even be formed by the thermal decomposition of a salt, e.g. sodium bicarbonate.

### Anionic Detersive Surfactant

The anionic detersive surfactant preferably comprises alkyl benzene sulphonate. Preferably the anionic detersive surfactant comprises at least 50%, preferably at least 55%, or at least 60%, or at least 65%, or at least 70%, or even at least 75%, by weight of the anionic detersive surfactant, of alkyl benzene sulphonate. Preferably the alkyl benzene sulphonate is a linear or branched, substituted or unsubstituted, C₈₋₁₈ alkyl benzene sulphonate. This is the optimal level of the C₈₋₁₈ alkyl benzene sulphonate to provide a good cleaning performance. The C₈₋₁₈ alkyl benzene sulphonate can be a modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548. Highly preferred C₈₋₁₈ alkyl benzene sulphonates are linear C₁₀₋₁₃ alkylbenzene sulphonates. Especially preferred are linear C₁₀₋₁₃ alkylbenzene sulphonates that are obtainable, preferably obtained, by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®.

The anionic detersive surfactant may preferably comprise other anionic detersive surfactants. A preferred adjunct anionic detersive surfactant is a non-alkoxylated anionic detersive surfactant. The non-alkoxylated anionic detersive surfactant can be an alkyl sulphate, an alkyl phosphate, an alkyl phosphonate, an alkyl carboxylate or any mixture thereof. The non-alkoxylated anionic surfactant can be selected from the group consisting of; C₁₀-C₂₀ primary, branched-chain, linear-chain and random-chain alkyl sulphates (AS), typically having the following formula:

CH₃(CH₂)ₓCH₂—OSO₃⁻M⁺

wherein, M is hydrogen or a cation which provides charge neutrality, preferred cations are sodium and ammonium cations, wherein x is an integer of at least 7, preferably at least 9; C₁₀-C₁₈ secondary (2,3) alkyl sulphates, typically having the following formulae:

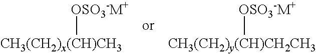

wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl carboxylates; mid-chain branched alkyl sulphates as described in more detail in U.S. Pat. No. 6,020,303 and U.S. Pat. No. 6,060,443; methyl ester sulphonate (MES); alpha-olefin sulphonate (AOS); and mixtures thereof.

Another preferred anionic detersive surfactant is an alkoxylated anionic detersive surfactant. The presence of an alkoxylated anionic detersive surfactant in the spray-dried powder provides good greasy soil cleaning performance, gives a good sudsing profile, and improves the hardness tolerance of the anionic detersive surfactant system. It may be preferred for the anionic detersive surfactant to comprise from 1% to 50%, or from 5%, or from 10%, or from 15%, or from 20%, and to 45%, or to 40%, or to 35%, or to 30%, by weight of the anionic detersive surfactant system, of an alkoxylated anionic detersive surfactant.

Preferably, the alkoxylated anionic detersive surfactant is a linear or branched, substituted or unsubstituted C₁₂₋₁₈ alkyl alkoxylated sulphate having an average degree of alkoxylation of from 1 to 30, preferably from 1 to 10. Preferably, the alkoxylated anionic detersive surfactant is a linear or branched, substituted or unsubstituted C₁₂₋₁₈ alkyl ethoxylated sulphate having an average degree of ethoxylation of from 1 to 10. Most preferably, the alkoxylated anionic detersive surfactant is a linear unsubstituted C₁₂₋₁₈ alkyl ethoxylated sulphate having an average degree of ethoxylation of from 3 to 7.

The alkoxylated anionic detersive surfactant, when present with an alkyl benzene sulphonate may also increase the activity of the alkyl benzene sulphonate by making the alkyl benzene sulphonate less likely to precipitate out of solution in the presence of free calcium cations. Preferably, the weight ratio of the alkyl benzene sulphonate to the alkoxylated anionic detersive surfactant is in the range of from 1:1 to less than 5:1, or to less than 3:1, or to less than 1.7:1, or even less than 1.5:1. This ratio gives optimal whiteness maintenance performance combined with a good hardness tolerance profile and a good sudsing profile. However, it may be preferred that the weight ratio of the alkyl benzene sulphonate to the alkoxylated anionic detersive surfactant is greater than 5:1, or greater than 6:1, or greater than 7:1, or even greater than 10:1. This ratio gives optimal greasy soil cleaning performance combined with a good hardness tolerance profile, and a good sudsing profile.

Suitable alkoxylated anionic detersive surfactants are: Texapan LEST™ by Cognis; Cosmacol AES™ by Sasol; BES151™ by Stephan; Empicol ESC70/U™; and mixtures thereof.

Preferably, the anionic detersive surfactant comprises from 0% to 10%, preferably to 8%, or to 6%, or to 4%, or to 2%, or even to 1%, by weight of the anionic detersive surfactant, of unsaturated anionic detersive surfactants such as alpha-olefin sulphonate. Preferably the anionic detersive surfactant is essentially free of unsaturated anionic detersive surfactants such as alpha-olefin sulphonate. By “essentially free of” it is typically meant “comprises no deliberately added”. Without wishing to be bound by theory, it is believed that these levels of unsaturated anionic detersive surfactants such as alpha-olefin sulphonate ensure that the anionic detersive surfactant is bleach compatible.

Preferably, the anionic detersive surfactant comprises from 0% to 10%, preferably to 8%, or to 6%, or to 4%, or to 2%, or even to 1%, by weight of alkyl sulphate. Preferably the anionic detersive surfactant is essentially free of alkyl sulphate. Without wishing to be bound by theory, it is believed that these levels of alkyl sulphate ensure that the anionic detersive surfactant is hardness tolerant.

### Volatile Compound

Typically, the volatile component has a boiling point of 125° C. or less, preferably 100° C. or less, preferably 90° C. or less, preferably 80° C. or less, preferably 70° C. or less, preferably 60° C. or less, preferably 50° C. or less, preferably 40° C. or less, preferably 30° C. or less, preferably 20° C. or less, preferably 10° C. or less, preferably 0° C. or less.

Preferably, the volatile compound is selected from the group consisting of: carbon dioxide in liquid form, including liquid carbon dioxide and carbon dioxide dissolved in an aqueous solution; carbonic acid. Preferably, the volatile compound is carbon dioxide.

Typically, the volatile component is formed by contacting carbon dioxide with the slurry, preferably an aqueous slurry.

The volatile component may even be water.

The volatile component may be in supercritical form. It may be especially preferred for the volatile component to be in supercritical form when it enters the nozzles.

Typically, the volatile component is in liquid form.

### Zeolite Builder

The powder typically comprises from 0% to 10 wt % zeolite builder, preferably to 9 wt %, or to 8 wt %, or to 7 wt %, or to 6 wt %, or to 5 wt %, or to 4 wt %, or to 3 wt %, or to 2 wt %, or to 1 wt %, or to less than 1% by weight of the powder, of zeolite builder. It may even be preferred for the powder to be essentially free from zeolite builder. By essentially free from zeolite builder it is typically meant that the powder comprises no deliberately added zeolite builder. This is especially preferred if it is desirable for the powder to be very highly soluble, to minimize the amount of water-insoluble residues (for example, which may deposit on fabric surfaces), and also when it is highly desirable to have transparent wash liquor. Zeolite builders include zeolite A, zeolite X, zeolite P and zeolite MAP.

### Phosphate Builder

The powder typically comprises from 0% to 10 wt % phosphate builder, preferably to 9 wt %, or to 8 wt %, or to 7 wt %, or to 6 wt %, or to 5 wt %, or to 4 wt %, or to 3 wt %, or to 2 wt %, or to 1 wt %, or to less than 1% by weight of the powder, of phosphate builder. It may even be preferred for the powder to be essentially free from phosphate builder. By essentially free from phosphate builder it is typically meant that the powder comprises no deliberately added phosphate builder. This is especially preferred if it is desirable for the powder to have a very good environmental profile. Phosphate builders include sodium tripolyphosphate.

### Silicate Salt

The powder optionally comprises from 0% to 20 wt % silicate salt, preferably from 1 wt %, or from 2 wt %, or from 3 wt %, and preferably to 15 wt %, or to 10 wt %, or even to 5% silicate salt. Silicate salts include amorphous silicates and crystalline layered silicates (e.g. SKS-6). A preferred silicate salt is sodium silicate.

### Carbonate Salt

The powder typically comprises carbonate salt, typically from 1% to 50%, or from 5% to 25% or from 10% to 20%, by weight of the powder, of carbonate salt. A preferred carbonate salt is sodium carbonate and/or sodium bicarbonate. A highly preferred carbonate salt is sodium carbonate. Preferably, the powder may comprise from 10% to 40%, by weight of the powder, of sodium carbonate. However, it may also be preferred for the powder to comprise from 2% to 8%, by weight of the powder, of sodium bicarbonate. Sodium bicarbonate at these levels provides good alkalinity whilst minimizing the risk of surfactant gelling which may occur in surfactant-carbonate systems. If the spray-dried powder comprises sodium carbonate and zeolite, then preferably the weight ratio of sodium carbonate to zeolite is at least 15:1.

High levels of carbonate improve the cleaning performance of the composition by increasing the pH of the wash liquor. This increased alkalinity: improves the performance of the bleach, if present; increases the tendency of soils to hydrolyse, which facilitates their removal from the fabric; and also increases the rate, and degree, of ionization of the soils to be cleaned (n.b. ionized soils are more soluble and easier to remove from the fabrics during the washing stage of the laundering process). In addition, high carbonate levels improve the flowability of the powder.

### Adjunct Detergent Ingredients

Suitable adjunct detergent ingredients include: detersive surfactants such as anionic detersive surfactants, nonionic detersive surfactants, cationic detersive surfactants, zwitterionic detersive surfactants, amphoteric detersive surfactants; preferred nonionic detersive surfactants are C₈₋₁₈ alkyl alkoxylated alcohols having an average degree of alkoxylation of from 1 to 20, preferably from 3 to 10, most preferred are C₁₂₋₁₈ alkyl ethoxylated alcohols having an average degree of alkoxylation of from 3 to 10; preferred cationic detersive surfactants are mono-C₆₋₁₈ alkyl mono-hydroxyethyl di-methyl quaternary ammonium chlorides, more preferred are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride; source of peroxygen such as percarbonate salts and/or perborate salts, preferred is sodium percarbonate, the source of peroxygen is preferably at least partially coated, preferably completely coated, by a coating ingredient such as a carbonate salt, a sulphate salt, a silicate salt, borosilicate, or mixtures, including mixed salts, thereof; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; enzymes such as amylases, carbohydrases, cellulases, laccases, lipases, oxidases, peroxidases, proteases, pectate lyases and mannanases; suds suppressing systems such as silicone based suds suppressors; fluorescent whitening agents; photobleach; filler salts such as sulphate salts, preferably sodium sulphate; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorhydrin; soil dispersants and soil anti-redeposition aids such as alkoxylated polyamines and ethoxylated ethyleneimine polymers; anti-redeposition components such as carboxymethyl cellulose and polyesters; perfumes; sulphamic acid or salts thereof; citric acid or salts thereof; and dyes such as orange dye, blue dye, green dye, purple dye, pink dye, or any mixture thereof.

### Further Embodiment

In a further embodiment, the present invention provides a process for preparing a powder comprising: (i) anionic detersive surfactant; (ii) from 0 wt % to 10 wt % zeolite builder; (iii) from 0 wt % to 10 wt % phosphate builder; and (iv) from 0 wt % to 15 wt % silicate salt; wherein the process comprises the steps of: (a) contacting an aqueous slurry with carbon dioxide to form a mixture; and (b) spraying the mixture through a nozzle into a drying apparatus; and (c) drying the slurry to form a powder.

Preferably the carbon dioxide is formed by the neutralization of an acid anionic surfactant precursor with a carbonate salt and/or thermal decomposition of a carbonate salt, typically a bicarbonate salt, most preferably sodium bicarbonate.

### EXAMPLES

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Example 1

### A Particulate Laundry Detergent Composition and Process of Making it

Aqueous slurry composition.

| Component | Aqueous slurry (parts) |
|---|---|
| Ethylenediamine disuccinic acid | 0.35 |
| Magnesium sulphate | 0.72 |
| Sodium silicate | 6.45 |
| Linear alkyl benzene sulphonate | 11.92 |
| Hydroxyethane di(methylene phosphonic acid) | 0.32 |
| Sodium carbonate | 4.32 |
| Sodium sulphate | 47.49 |
| Water | 25.89 |
| Miscellaneous | 0.42 |
| Total Parts | 100.00 |

### Preparation of a Spray-Dried Powder.

An aqueous slurry having the composition as described above is prepared having a moisture content of 25.89%. The aqueous slurry is heated to 72° C. and pumped into a low pressure line (having a pressure of 5×10⁵ Pa), and then into a high pressure line (having an exit pressure of 8×10⁶ Pa). Liquid CO₂ is injected into the high pressure line. The resultant slurry is then sprayed at pressure of 8×10⁶ Pa and at a temperature of 65° C. through a nozzle into a counter-current spray-drying tower with an air inlet temperature of from 270° C. to 300° C. and at a pressure of less than 1×10⁵ Pa. The aqueous slurry is atomised and the atomised slurry is dried to produce a solid mixture, which is then cooled and sieved to remove oversize material (>1.8 mm) to form a spray-dried powder, which is free-flowing. Fine material (<0.15 mm) is elutriated with the exhaust air in the spray-drying tower and collected in a post tower containment system. The spray-dried powder has a moisture content of 2.5 wt %, a bulk density of 427 g/l and a particle size distribution such that 95.2 wt % of the spray-dried powder has a particle size of from 150 to 710 micrometers. The composition of the spray-dried powder is given below.

Spray-dried powder composition.

| | % |
|---|---|
| Component | w/w Spray-dried powder |
| Magnesium sulphate | 0.96 |
| Sodium silicate | 8.62 |
| Linear alkyl benzene sulphonate | 15.92 |
| Hydroxyethane di(methylene phosphonic acid) | 0.43 |
| Sodium carbonate | 5.77 |
| Sodium sulphate | 63.43 |
| Water | 2.5 |
| Miscellaneous | 0.55 |
| Total Parts | 100.00 |

A granular laundry detergent composition.

| | % w/w |
|---|---|
| | granular |
| | laundry |
| | detergent |
| Component | composition |
| Spray-dried powder of example 1 (described above) | 59.38 |
| 91.6 wt % active linear alkyl benzene sulphonate flake | 0.22 |
| supplied by Stepan under the tradename Nacconol 90G ® | |
| Citric acid | 5.00 |
| Sodium percarbonate | |
| (having from 12% to 15% active AvOx) | 14.70 |
| Photobleach particle | 0.01 |
| Lipase (11.00 mg active/g) | 0.70 |
| Amylase (21.55 mg active/g) | 0.33 |
| Protease (56.00 mg active/g) | 0.43 |
| Tetraacetyl ethylene diamine agglomerate (92 wt % active) | 4.35 |
| Suds suppressor agglomerate (11.5 wt % active) | 0.87 |
| Acrylate/maleate copolymer particle (95.7 wt % active) | 0.29 |
| Green/Blue carbonate speckle | 0.50 |
| Sodium Sulphate | 9.59 |
| Ethoxylated C₈-C₁₈ alcohol having an average degree of | 3.00 |
| ethoxylation of 7 (AE7) | |
| Solid perfume particle | 0.63 |
| Total Parts | 100.00 |

The above laundry detergent composition was prepared by dry-mixing all of the above particles (all except the AE7) in a standard batch mixer. Liquid AE7 is then sprayed onto the particles. Alternatively, liquid AE7 is sprayed onto the spray-dried particles, and the resultant particles are then dry-added with all of the above particles.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for preparing a powder comprising:
(i) anionic detersive surfactant;
(ii) from about 0 wt % to about 10 wt % zeolite builder;
(iii) from about 0 wt % to about 10 wt % phosphate builder; and
(iv) from about 0 wt % to about 15 wt % silicate salt;
wherein the process comprises the steps of:
(a) forming a slurry that comprises a volatile compound; and
(b) spraying the slurry through a nozzle into a drying apparatus; and
(c) drying the slurry to form a powder,
wherein the slurry enters the nozzle at conditions such that either:
(I) at the temperature at which the slurry enters the nozzle, the slurry is at a pressure that is equal to or greater than the vapour pressure of the volatile component, and wherein, the slurry enters the nozzle at a temperature such that the vapour pressure of the volatile compound is above the pressure in the drying apparatus; or
(II) the volatile component is in supercritical form when the slurry enters the nozzle, and wherein, the conditions in the drying apparatus are such that when the volatile component enters the drying apparatus, at least a portion of the volatile component is in gaseous form.

2. A process according to claim 1, wherein the volatile compound is selected from the group consisting of: carbon dioxide in liquid form, including liquid carbon dioxide and carbon dioxide dissolved in an aqueous solution; carbonic acid.

3. A process according to claim 1, wherein in step (b) the mixture is sprayed at a temperature of below about 100° C. into the drying apparatus.

4. A process according to claim 1, wherein the powder is in spray-dried form, and wherein the drying apparatus is a spray-drying tower.

5. A process according to claim 1, wherein the drying apparatus is a powder mixing apparatus.

6. A process according to claim 1, wherein the drying apparatus is a fluid bed dryer.

7. A process according to claim 1, wherein the powder produced in step (c) is contacted with non-ionic detersive surfactant.

8. A process for preparing a powder comprising:
(i) anionic detersive surfactant;
(ii) from about 0 wt % to about 10 wt % zeolite builder;
(iii) from about 0 wt % to about 10 wt % phosphate builder; and
(iv) from about 0 wt % to about 15 wt % silicate salt;
wherein the process comprises the steps of:
(a) contacting an aqueous slurry with carbon dioxide to form a mixture; and
(b) spraying the mixture through a nozzle into a drying apparatus; and
(c) drying the slurry to form a powder.

9. A process according to claim 7, wherein the carbon dioxide is formed by the neutralization of an acid anionic surfactant precursor with a carbonate salt.
